(19) United States
(12) Patent Application Publication
(10) Pub. No.: US 2025/0254355 A1
(43) Pub. Date: Aug. 7, 2025

(54) METHOD AND DEVICE FOR SUB-PIXEL REFINEMENT OF MOTION VECTORS

(71) Applicant: Samsung Electronics Co., Ltd., Suwon-si (KR)

(72) Inventors: Petr POHL, Lobnya (RU); Alexey Bronislavovich DANILEVICH, Moscow (RU); Sergey Yurievich PODLESNYY, Moscow (RU); Alexander Viktorovich YAKOVENKO, Novosibirsk Region (RU); Evgeny Andreevich MOSKOVTSEV, Balashikha (RU); Timur Erkinovich ALIEV, Moscow (RU)

(21) Appl. No.: 19/191,614

(22) Filed: Apr. 28, 2025

Related U.S. Application Data
(63) Continuation of application No. PCT/KR2023/012425, filed on Aug. 22, 2023.

(30) Foreign Application Priority Data
Nov. 21, 2022 (RU) 2022130183

(51) Int. Cl. H04N 19/513; H04N 19/105; H04N 19/172

(52) U.S. Cl. CPC H04N 19/521; H04N 19/105; H04N 19/172

(57) ABSTRACT

A method performed by an electronic device for sub-pixel refinement of motion vectors is provided. The method includes obtaining, by the electronic device, a pair of adjacent video frames, generating, by the electronic device, a noise prediction map on a frame from the pair of adjacent frames based on a predefined noise model, obtaining, by the electronic device, the motion vectors by performing block-based motion estimation between the adjacent video frames, and determining, by the electronic device, whether to perform the sub-pixel refinement of the motion vectors based on the noise prediction map.

### CROSS-REFERENCE TO RELATED APPLICATION(S)

This application is a continuation application, claiming priority under § 365 (c), of an International application No. PCT/KR2023/012425, filed on Aug. 22, 2023, which is based on and claims the benefit of a Russian patent application number 2022130183, filed on Nov. 21, 2022, in the Russian Intellectual Property Office, the disclosure of which is incorporated by reference herein in its entirety.

### BACKGROUND

### 1. Field

The disclosure relates to video data processing. More particularly, the disclosure relates to a method and device for sub-pixel refinement of motion vectors.

### 2. Description of Related Art

High-definition video data (e.g., 4K or more) cannot yet be processed (with optical flow estimation) in full resolution at rate of 1/33 ms. To enable this in the prior art, the processing associated with motion estimation is usually performed at a reduced resolution, and sub-pixel refinement is usually used to achieve sufficient accuracy. In addition, up-to-date motion estimation (ME) algorithms are extremely sensitive to content quality and image noise levels. In an attempt to improve the accuracy of motion estimation, some prior art algorithms collect statistics from images and apply the statistics directly in the process of processing such images. Although this approach can improve the accuracy of motion estimation, in-depth image analysis required in it increases the processing time and increases the computational complexity.

U.S. Pat. No. 9,721,330 B2 (Huawei Technologies Co. Ltd.) published on Aug. 1, 2017 discloses an estimation of the true optical flow between the current frame and buffered previous frames. The image noise reduction method proposed in said patent is based on the analysis of image noise caused by quantization, followed by evaluation of image regions with transitions and edges directly in the process of processing said images. Thus, the disclosure of the '330 patent suffers from at least some of the above problems, since in-depth analysis of image features in real time may lead to increased processing time and increased computational complexity of such implementation. The disclosure of the '330 patent may be considered as the closest prior art.

Other video processing technologies with motion estimation are known from the prior art, which can be considered to some extent close to the technology disclosed in the patent application, see, for example, US Patent Application Publication US2014192267A1 of Jul. 10, 2014 (Qualcomm Inc.), US Patent Application Publication US2019244330A1 of Aug. 8, 2019 (Apple Inc.), as well as the US patent U.S. Pat. No. 8,175,160 B1 of Aug. 5, 2012 (Nvidia Corp.). Like the closest prior art, the solutions described in the listed patent documents suffer from at least some of the above described problems, since they are supposed to collect local statistics regarding certain features of real-time processed images and/or their implementation is supposed to be performed by powerful graphics processing units (GPUs). Thus, the solutions disclosed in the above patent documents, when attempting to implement them on resource-constrained mobile devices, will be characterized by increased processing time and excessive computational complexity.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for sub-pixel refinement of motion vectors.

Additional aspects will be set forth in part in the description which follows and, in part, will be apparent from the description, or may be learned by practice of the presented embodiments.

In accordance with an aspect of the disclosure, a method performed by an electronic device for sub-pixel refinement of motion vectors is provided. The method includes obtaining, by the electronic device, a pair of adjacent video frames, generating, by the electronic device, a noise prediction map on a frame from the pair of adjacent frames based on a predefined noise model, obtaining, by the electronic device, the motion vectors by performing block-based motion estimation between the adjacent video frames, and determining, by the electronic device, whether to perform the sub-pixel refinement of the motion vectors based on the noise prediction map.

In accordance with another aspect of the disclosure, an electronic device for sub-pixel refinement of motion vectors is provided. The electronic device includes memory storing one or more computer programs, and one or more processors communicatively coupled to the memory, wherein the one or more computer programs include computer-executable instructions that, when executed by the one or more processors individually or collectively, cause the electronic device to obtain a pair of adjacent video frames, generate a noise prediction map on a frame from the pair of adjacent frames based on a predefined noise model, obtain the motion vectors by performing block-based motion estimation between the adjacent video frames, determine whether to perform the sub-pixel refinement of the motion vectors based on the noise prediction map.

The one or more computer programs further include computer-executable instructions that, when executed by the one or more processors individually or collectively, cause the electronic device to perform the sub-pixel refinement of the motion vectors for at least one block of the frame based on the determination to perform the sub-pixel refinement of the motion vectors.

In accordance with another aspect of the disclosure, one or more non-transitory computer-readable storage media, storing one or more computer programs including computer-executable instructions that, when executed by one or more processors of an electronic device for sub-pixel refinement of motion vectors individually or collectively, cause the electronic device to perform operations are provided. The operations include obtaining, by the electronic device, a pair of adjacent video frames, generating, by the electronic device, a noise prediction map on a frame from the pair of adjacent frames based on a predefined noise model, obtaining, by the electronic device, the motion vectors by performing block-based motion estimation between the adjacent video frames, and determining, by the electronic device, whether to perform the sub-pixel refinement of the motion vectors based on the noise prediction map.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart of a method of sub-pixel refinement of motion vectors according to an embodiment of the disclosure;

FIG. 2 is a flowchart of motion vector refinement in the method according to an embodiment of the disclosure;

FIG. 3 is a flowchart of a method of sub-pixel refinement of motion vectors according to an embodiment of the disclosure;

FIG. 4 is a block diagram of an electronic device according to an embodiment of the disclosure;

FIG. 5 is a graph illustrating calculation difference metrics when refining a motion vector according to an embodiment of the disclosure;

FIG. 6 is a graph illustrating equiangular one-dimensional approximation of difference metric versus sub-pixel displacement, which is considered in one or several directions, which can be used as one of possible methods of finding sub-pixel displacement of a motion vector according to an embodiment of the disclosure;

FIG. 7 is a graphical representation of two-dimensional approximation of difference metric versus sub-pixel displacement by a conic surface, which can be used as another of possible methods of finding sub-pixel displacement of a motion vector according to an embodiment of the disclosure;

FIG. 8 is a graphical representation of a predefined noise model applied in a method of sub-pixel refinement of motion vectors when determining a noise prediction map for a frame according to an embodiment of the disclosure;

FIG. 9 illustrates a noisy image, a noise prediction map, a lower noise map, a standard deviation map of image pixel intensity values, an image details map, and a motion refinement map according to an embodiment of the disclosure; and

FIG. 10 is a flowchart of a method for sub-pixel refinement of motion vectors according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

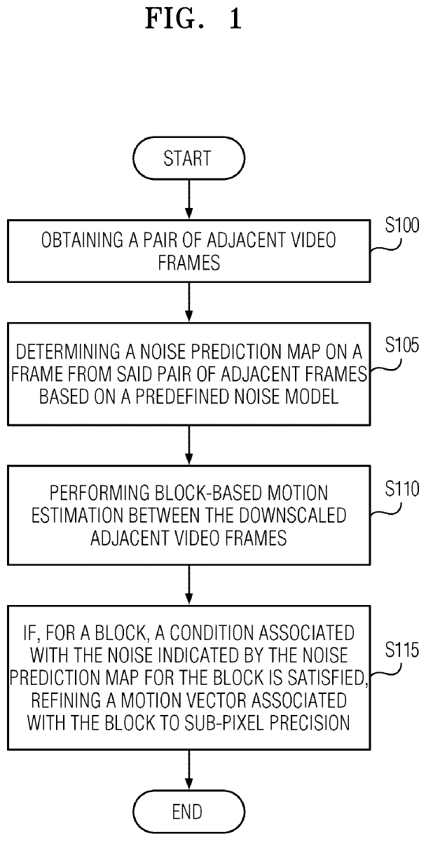

FIG. 1 is a flowchart of a method of sub-pixel refinement of motion vectors according to an embodiment of the disclosure.

Referring to FIG. 1, at operation S100, at least one pair of adjacent video frames is obtained. The term ‘adjacent frames’ hereinafter refers to frames located next to each other in a video sequence, for example, frames that are directly adjacent in time, or frames that are not directly adjacent to each other in time, but located close to each other in the video sequence, for example, frames located one, two or three frames apart. Obtaining frames at operation S100 may include both directly capturing at least a pair of video frames and obtaining at least a pair of frames from previously captured and stored video.

At operation S105, a noise prediction map Nᵢⱼ is determined on any one or both frames from said pair of adjacent frames based on a predefined noise model. If the noise prediction map Nᵢⱼ is determined on both frames, then one combined map obtained, for example, by averaging individual noise maps Nᵢⱼ can be used. The predefined noise model is obtained in advance for a particular camera sensor and a particular image-processing pipeline applied. The term ‘predefined’ as used herein means that the model for a specific camera model and/or operation sequence of an image-processing pipeline is obtained in advance. In the preferred embodiment of the disclosure, the predefined noise model is obtained on a device (equipped with a specific camera model and using a specific image-processing pipeline sequence) on which such a noise model will subsequently be used to perform sub-pixel refinement of motion vectors (for example, when capturing/encoding/decoding video). As an example, the predefined noise model may be generated in manufacturing the device by the manufacturer or obtained by the end user of the device during, for example, a device initial setup procedure or a device camera initial calibration procedure. The predefined noise model may be updated (i.e., re-generated) during use of the device automatically (e.g., on a regular basis) or at the user's request. In addition, a separate noise model can be obtained for each shooting mode (for example, auto, night, portrait, landscape, macro) available on a particular camera, and then a corresponding noise model can be selected depending on a selected shooting mode.

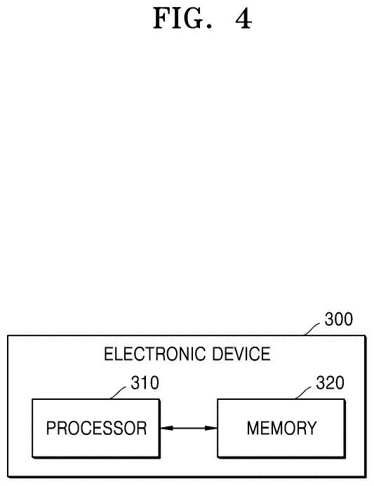

In the non-limiting embodiment of the disclosure, camera (see FIG. 4) includes a sensor covered with a Bayer filter commonly used for color imaging. In addition, the camera contains or is connected to an analog-to-digital converter configured to convert the input analog image signal into a digital image signal. In the non-limiting embodiment of the disclosure, the image-processing pipeline (image signal processing (ISP) pipeline) that processes a digital image signal obtained by the camera may include, but is not limited to, one or more of the following stages demosaicing, shading correction (correction of distortions introduced by the optical part of the camera), geometric correction, tone correction (e.g., gamma correction), and encoding (including quantization) into a specific format (e.g., but not limited to, YUV 4:2:0 format, YUV 4:2:2 format). The above details are known in the art and therefore will not be described here. As the non-limiting example, image demosaicing and initial denoising may be performed according to the technology described in RU 2020138295 (SAMSUNG ELECTRONICS CO., LTD.), the full disclosure of which is incorporated herein by reference.

In the non-limiting embodiment of the disclosure, the predefined noise model may be generated by performing the following operations. (A) Capturing, using a camera sensor and an image-processing pipeline applied, a plurality of sets of frames. Frames included in a data set are captured in a static position for a static scene with fixed illumination, exposure, sensor sensitivity (g) and focus. Different sets of frames in said plurality of sets of frames differ from each other in at least one of static position, static scene, illumination, exposure, sensor sensitivity, and focus. In a preferred embodiment of the disclosure, the different sets of frames in said plurality of sets of frames differ from each other only in sensor sensitivity (i.e., each set of frames is captured with a corresponding known sensor sensitivity level). The term ‘static scene’ means that positions of objects that fall into the camera lens do not substantially change from frame to frame. The term ‘static position’ means that the camera is in a stationary state when shooting frames included in the set (for example, shooting is performed from a tripod). The term ‘fixed illumination’ means that the number and intensity of light sources in the scene being shot do not substantially change from frame to frame.

Next, at operation (B), a plurality of portions in each frame of each set are specified and the position of each portion in the frame is determined. Preferably, the plurality of portions in each frame are specified in the same way in all frames of a set and in all sets. As an example, the plurality of portions in each frame of each set may be specified by a regular grid defining the plurality of such portions. The minimum size of a portion may be equal to one pixel, and the maximum size of a portion may be equal to about one-tenth of a frame or more. Preferably, a size of specified portions in all frames of all sets of frames is set to be the same size. Suitable size of a frame portion in pixels may be increased as a resolution of a processed frame increases and reduced as a resolution of a processed frame decreases. In non-limiting examples, the portion may be a square block 2×2, 4×4, 8×8, 16×16, 32×32, 64×64, 128×128, such a block may have other sizes (for example, any intermediate or larger sizes). In other non-limiting examples, the portion may be a rectangular block 2×4, 4×2, 4×8, 8×4, 8×16, 16×8, 16×32, 32×16, 32×64, 64×32, 64×128, 128×64, 128×256, 256×128, such a block may have other sizes (for example, any intermediate or larger sizes). Thus, a shape of a portion can be both rectangular and square. Position of each portion in a frame can be stored in memory. Position of each portion in a frame can be represented by coordinates of a specific pixel of that frame portion (for example, but not limited to, top left pixel, top right pixel, bottom left pixel, bottom right pixel, or center pixel of that frame portion) relative to the origin in the whole frame (for example, but not limited to, top left pixel, top right pixel, bottom left pixel, bottom right pixel, or center pixel of that frame).

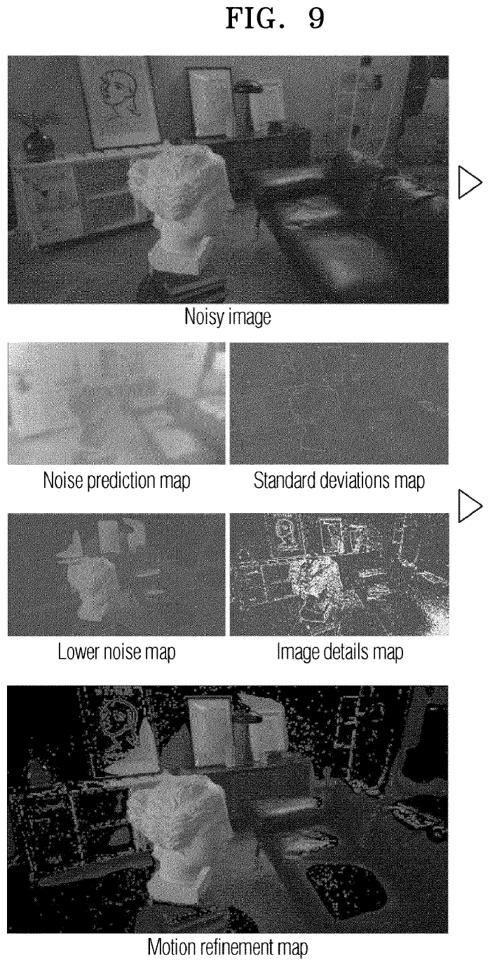

Next, at operation (C), at least the following characteristics are determined in each set of frames between frame portions within the same position: standard deviation sᵢⱼ^{m} of pixel intensity values, mean pixel luminosity (luma) value mean ( [symbol] i,j) camera sensor gain g level when capturing the frame, relative distance r from the frame center to the considered frame portion. Then, by approximating determined positions of frame portions and the characteristics determined in said positions with a low-parametric function, a low-dimensional parametric noise model for said camera sensor and said image-processing pipeline, which were used at operation (A), is obtained. Thus, such a parametric noise model is adapted to determine the noise prediction map Nᵢⱼ for an arbitrary frame captured by such a camera sensor and image-processing pipeline. Illustrative examples of the noisy image and the noise prediction map Nᵢⱼ determined for it by the predefined noise model are shown in FIG. 9.

The following describes the non-limiting example of the implementation of generating the predefined noise model and provides a corresponding mathematical description. This example and any mathematical expressions that follow should not be interpreted as limiting, as other possible modifications to the implementation of generating the predefined noise model will become apparent to those of ordinary skill in the art after reading this disclosure. All such modifications are intended to be within the embodiment of the disclosure.

Generation of the predefined noise model starts from setting up (1) a scene under controlled lighting conditions with static positions of objects, camera, and light sources. The light sources shall provide a stable light intensity, i.e. substantially flicker-free light intensity. Next, N frames (N≥2) are captured (2) with the corresponding camera sensor gain level (g₁ . . . g_{N})∈ [symbol] ^{N}. In one example, all frames in a set may have substantially the same camera sensor gain level, but different sets of frames may have their own (different and/or the same) camera sensor gain levels. After that, operations (1)-(2) are repeated (3) M times (M≥1) and a plurality of M sets of N noisy static frames (Y₁¹, . . . , Y_{N}¹, . . . , Y₁^{M}, . . . , Y_{N}^{M},)∈ [symbol] ^{M·N·w·h} is formed, where w is the width of the frame luminosity channel and h is the height of the frame luminosity channel. Each set contains N frames captured in a static position, for a static scene and illumination, the frames Y₁^{m}, . . . , Y_{N}^{m} differ only by a random noise level. The formed plurality of M sets of N noisy static frames can be stored in the memory.

Next, for each 1 . . . . M set of frames the standard deviation sᵢⱼ^{m} of pixel intensity values is calculated between corresponding frame portions. The corresponding portions here may be individual pixels of each frame in a set with the same coordinates (i, j) or larger portions of each frame in the set within the same positions indicated by coordinates (i, j). The calculation of the standard deviation sᵢⱼ^{m} of pixel intensity values can be performed using the formula:

$${s}_{ij}^{m} = \sqrt{\frac{1}{N} {\sum }_{p = 1}^{N} {( {Y}_{p}^{m} [ i , j ] - {\hat{Y}}^{m} [ i , j ] )}^{2}} \qquad Equation l$$

Each frame can be further smoothed at operation (5) according to any prior art image smoothing technique. In the non-limiting example, smoothing may be performed by a Gaussian filter, a bilateral filter, a non-local smoothing algorithm, and so on. This operation (5) is optional. Next, at operation (6), a data set D for approximation is produced as follows:

$$D [ {g}_{n} , {r}^{2} ( i , j ) , mean ( i , j ) ] \qquad Equation 2$$

$$∀ n ∈ 1 … N ,$$

$$∀ m ∈ 1 … M ,$$

$$∀ i ∈ 1 … h ,$$

$$∀ j ∈ 1 … w$$

$$where$$

$${r}^{2} ( i , j ) = \frac{1}{4} ( {( w - i )}^{2} + {( h - j )}^{2} ) \qquad Equation 3$$

$$mean ( i , j ) = \frac{1}{4 {s}^{2}} {\sum }_{p = i - d}^{i + d} {\sum }_{q = j - d}^{j + d} [ p , q ] \qquad Equation 4$$

gₙ is the camera sensor gain level with which the corresponding set of frames was captured. r²(i,j) is the squared relative distance from the pixel with coordinates (i, j) or the frame portion indicated by coordinates (i, j) to the frame center, r² (i,j) may be called the radius. mean( [symbol] i,j) a is mean luminosity value of pixels/frame portions. Finally, the resulting data set D is approximated by a low-parametric function to obtain a low-dimensional parametric noise model for the camera sensor and the image-processing pipeline applied when capturing the frames at operation (2). The low-parametric function might take the following form:

$$F ( x ) = a log ( b x - c ) exp ( - d {x}^{2} ) + e \qquad Equation 5$$

where a, b, c, d, e are the approximation coefficients.

The resulting low-dimensional parametric noise model F can be stored in the memory in any form suitable for subsequent use, for example, but without limitation, in the form of a lookup table. If the generation of the noise model F as described above was performed on an external device based on video frames previously captured by the user end device's camera and processed by its image-processing pipeline, the generated noise model F shall be additionally uploaded to such user end device in order to be usable on such end user device for performing sub-pixel refinement of motion vectors (for example, when capturing/encoding/decoding video on this device).

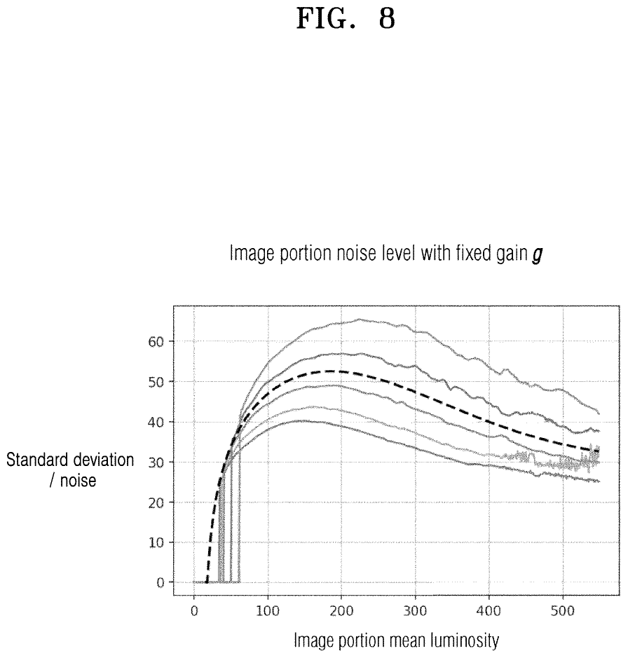

FIG. 8 is a graphical representation of a noise model F that is generated by an above-described workflow on certain experimental data according to an embodiment of the disclosure.

Referring to FIG. 8, such a noise model F can be applied in the method of sub-pixel refinement of motion vectors. The dashed line in FIG. 8 shows the curve approximating the dependency of noise level sᵢⱼ^{m} in terms of luminance from mean luminance mean( [symbol] i,j) of the image portion for the particular camera sensor gain level g and particular pixel/frame portion position r²(i,j) It is clear that the noise model F may include data for a plurality of other defined gain levels g of the camera sensor. In this case, based on such data, it would be possible to construct, similarly to FIG. 8, a plurality of other approximating curves to be applied in one case or another. The solid lines are curves constructed from the experimental data (e.g., for each corresponding set of M) of the dependency of noise level sᵢⱼ^{m} in terms of luminance from mean luminance mean( [symbol] i,j) of the image portion for the corresponding (i.e., the same as that of the approximating curve) camera sensor gain level g at different pixel/frame portions r²(i,j).

Thus, the generated noise model F is capable of determining a noise map Nᵢⱼ for an arbitrary captured frame, provided that this frame is captured by the same camera and processed by the same image-processing pipeline, which were used for capturing and processing images based on which the corresponding noise model was generated. The determination of the noise map Nᵢⱼ itself is performed by predicting the standard deviations sᵢⱼ^{m} of pixel intensity values of all frame portions depending on the positions of the corresponding frame portions, the corresponding mean pixel luminosity values mean( [symbol] i,j), as well as on the corresponding camera sensor gain level g.

The use of the noise model configured in advance for a particular device allows to minimize the processing to be performed when using this device directly to perform sub-pixel refinement of motion vectors (for example, when capturing/encoding/decoding video). Said processing minimization is achieved due to elimination of the need to analyze the processed images to collect any statistics directly in the process of using the device by an end user. In addition, the use of the predefined noise model makes it possible to make the sub-pixel refinement of motion vectors adaptive to noise, and this adaptability, in turn, makes it possible to improve the accuracy of the motion vector refinement even more.

The following describes the non-limiting example of the implementation of determination at operation S105 of the noise prediction map Nᵢⱼ on a frame of said pair of adjacent frames based on the previously generated noise model F and provides the corresponding mathematical description. This example and any mathematical expressions that follow should not be interpreted as limiting, as other possible modifications to the implementation of determination at operation S105 of the noise prediction map Nᵢⱼ will become apparent to those of ordinary skill in the art after reading this disclosure. All such modifications are intended to be within the scope of the embodiment of the disclosure.

It is assumed that a pair of adjacent video frames Y₁, Y₂∈ [symbol] ^{w·j} (where w is the luminosity channel width of the frames Y₁, Y₂, and h is the luminosity channel height of the frames Y₁. Y₂) has already been obtained at operation S100 by the user device (with the particular camera) and processed by the particular image-processing pipeline, and previously, for such a user device configuration (with said camera and image-processing pipeline) the predefined noise model F was obtained and stored in the memory of this device. Each frame Y₁, Y₂ can be further smoothed according to any prior art image smoothing technique. In the non-limiting example, smoothing may be performed by a Gaussian filter, a bilateral filter, a non-local smoothing algorithm, and so on.

By having the information described above available, the noise prediction map Nᵢⱼ is determined at operation S105 as follows:

$${N}_{i , j} = F ( g , {r}_{i , j}^{2} , {\tilde{\tilde{Y}}}_{i , j} ) \qquad Equation 6$$

$$where$$

$${r}_{i , j}^{2} = \frac{1}{4} ( {( w - i )}^{2} + {( h - j )}^{2} ) \qquad Equation 7$$

$${\tilde{\tilde{Y}}}_{i , j} = \frac{1}{4 {s}^{2}} {\sum }_{n = i - s}^{i + s} {\sum }_{m = j - s}^{j + s} {\tilde{Y}}_{n , m} \qquad Equation 8$$

where Y is the original luminosity channel;
\tilde{Y} is a smoothed and optionally downscaled luminosity channel;
\tilde{Y} is the mean luminosity value in the considered image portion,
s is the size of the square portion in pixels if the square portion is considered. Thus, for the noise prediction map Nᵢⱼ mean luminosity values are calculated on the already smoothed image.

The lower noise map Cᵢⱼ¹, which illustrative example is shown in FIG. 9, can be determined, provided that the noise prediction map Nᵢⱼ is known, as follows:

$${C}_{ij}^{1} = \{ \begin{matrix}1 , & {N}_{ij} < T \\ & 0\end{matrix} \qquad Equation 9$$

where T is the p-^{th} percentile of Nᵢⱼ.

The image details map Cᵢⱼ², which illustrative example is shown in FIG. 9, can be determined, provided that the noise prediction map Nᵢⱼ and pixel luminosity values Yᵢⱼ are known, as follows (STDEV means calculation of standard deviation):

$${c}_{ij}^{2} = \{ \begin{matrix}1 , & STDEV ( {Y}_{ij} ) > {N}_{ij} \\ & 0\end{matrix} \qquad Equation 10$$

Now returning back to the description of the flowchart of the method of FIG. 1. After operation S105 is executed, block-based motion estimation is performed at operation S110 between adjacent downscaled video frames. Block-based motion estimation can be performed by any method known in the art. Block-based motion estimation may include the implementation of any known block-matching algorithm. In the embodiment of the disclosure, block-based motion estimation of adjacent video frames with quantization to integer pixel values is performed by carrying out the following sequence of operations, in which (a) using a motion vector field determined previously for a previous pair of adjacent frames, estimating a forward motion vector field for a current pair of adjacent frames in a first spatial resolution, (b) using the forward motion vector field obtained by the estimation at operation (a), estimating a backward motion vector field for the current pair of adjacent frames in the first spatial resolution, (c) using the backward motion vector field obtained by the estimation at operation (b), estimating a forward motion vector field for the current pair of adjacent frames in a second spatial resolution, and (d) using the forward motion vector field obtained by the estimation at operation (c), estimating a backward motion vector field for the current pair of adjacent frames in the second spatial resolution. The second spatial resolution is greater than the first spatial resolution. In the other non-limiting example, block-based motion estimation may be performed according to the technology described in RU 2020132721 (SAMSUNG ELECTRONICS CO., LTD.), the full disclosure of which is incorporated herein by reference.

Downscaling can be performed by any method known in the art. As non-limiting examples, Lanczos resampling, bilinear or bicubic algorithms, block sampling, MIP mapping, or any combination thereof can be used. The block that is found by motion estimation at operation S110 may be one pixel or larger in size. As an example, the block may be a square block 2×2, 4×4, 8×8, 16×16, 32×32, 64×64, 128×128, such a block may have other sizes (for example, any intermediate or larger sizes). In other non-limiting examples, the block may be a rectangular block 2×4, 4×2, 4×8, 8×4, 8×16, 16×8, 16×32, 32×16, 32×64, 64×32, 64×128, 128×64, 128×256, 256×128, such a block may have other sizes (for example, any intermediate or larger sizes). The motion estimation performed at operation S110 is integer (or pixel values are quantized to integer values), because it is performed with accuracy up to a whole block of pixels or up to a whole pixel, but never goes into the sub-pixel range.

Next, proceeding to the execution of operation S115, in which, for frame blocks for which a condition associated with the noise indicated for the block by the noise prediction map Nᵢⱼ is met, the motion vector associated with such a block is refined to sub-pixel precision. The block for which the condition is checked to determine whether it is reasonable to refine the motion vector to sub-pixel precision may be a block from which the found motion vector points, and/or a block to which the found motion vector points. In an embodiment of the disclosure, the condition being checked to determine whether it is reasonable to refine the motion vector for the block to sub-pixel precision is further associated with image details indicated for said block by image details map Cᵢⱼ² obtained based on the noise prediction map Nᵢⱼ. Illustrative examples of a noisy image Y and the resulting image details map Cᵢⱼ² are shown in FIG. 9.

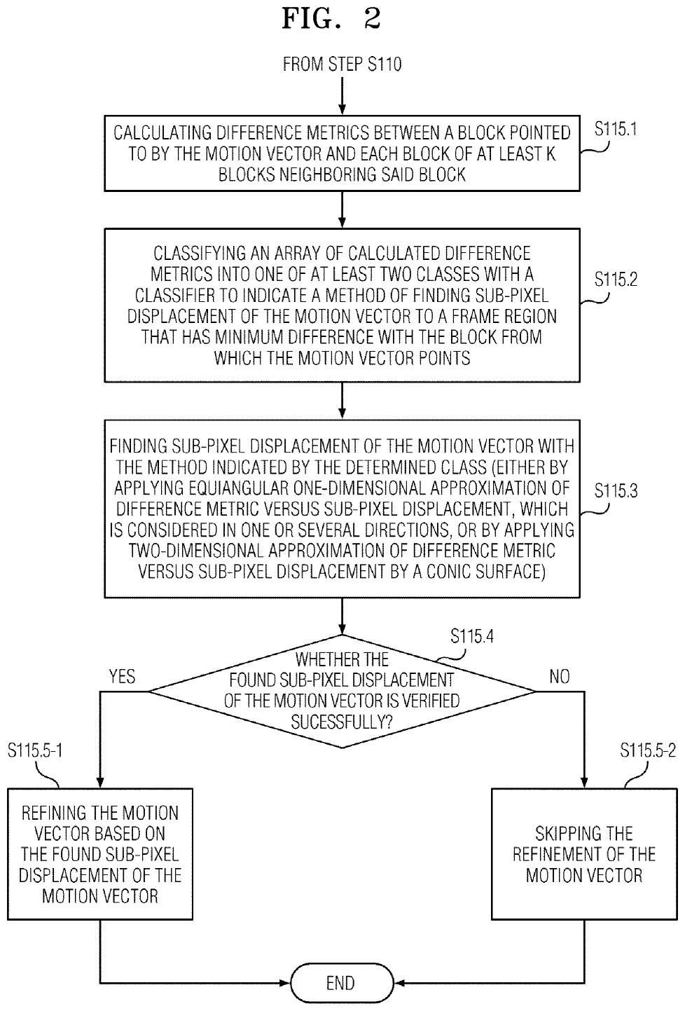

FIG. 2 is a flowchart of sub-pixel precision motion vector refinement operation S115 in the method according to an embodiment of the disclosure.

Referring to FIG. 2. the refinement at operation S115 of the motion vector associated with the block starts from the execution of sub-operation S115.1, in which difference metrics between a block pointed to by the previously found motion vector and each block of at least k blocks neighboring said block are calculated. The difference metric can be any metric known in the art, such as sum of absolute differences (SAD), mean square error (MSE), peak signal-to-noise ratio (PSNR), structural similarity index measure (SSIM) and so on. The term ‘difference metric’ as used herein should be understood as including image similarity metric that can be expressed as an inverse value of the difference metric. Each neighboring block of the at least k blocks used in calculating operation S115.1 the difference metric is a block that has the same shape, height and width in pixels as the block to which said motion vector points. This may be desirable to ensure comparability of compared image portions. Furthermore, each neighboring block of the at least k blocks used in calculating operation S115.1 the difference metric may be a block that does not overlap with the block to which said motion vector points, or a block that at least partially overlaps with the block to which said motion vector points.

Next, proceeding to the execution of sub-operation S115.2, in which the whole array of calculated difference metrics is classified into one of at least two classes with a classifier. In one embodiment of the disclosure, the classifier may be implemented by applying an empirically established predetermined threshold value used for comparison with an averaged difference metric obtained by averaging the whole array of calculated difference metrics. With such an implementation of the classifier, if the averaged difference metric is greater than or equal to the predetermined threshold value, a first class is determined by the classification, if the averaged difference metric is less than the predetermined threshold value, a second class is determined by the classification, or vice versa. In other embodiments of the disclosure, the classifier may be implemented as any classifier known in the art, e.g. as the classifier based on linear regression, support vector machine, decision trees, neural network. In such embodiments of the disclosure, training of the classifier can be carried out based on a computational experiment conducted in offline mode (i.e. before the actual use of the device by an end user), based on statistics collected experimentally in offline mode or based on training data synthesized in offline mode and so on.

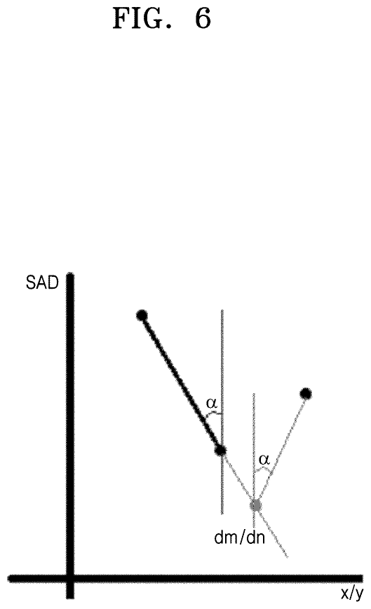

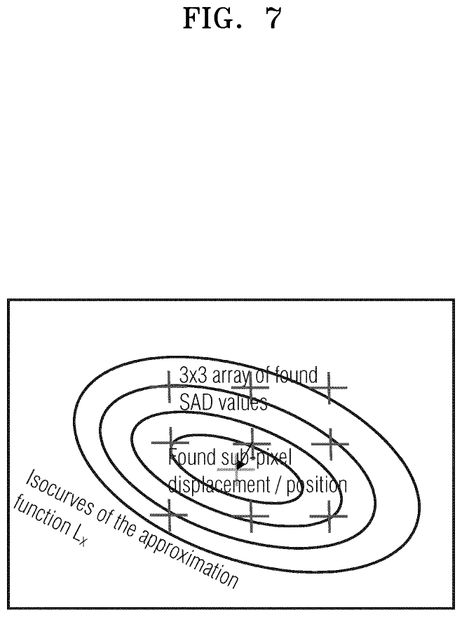

The class determined by the classifier at sub-operation S115.2 indicates a method of finding sub-pixel displacement of the previously found motion vector to a frame region that has minimum difference/maximum similarity with the block from which the motion vector points. It is assumed that the frame region to which the found sub-pixel motion vector displacement points has substantially the same shape and size as the block from which this motion vector points (i.e., the block for which the found motion vector is being refined) to ensure comparability of image portions in determining minimum difference/maximum similarity. The method of finding sub-pixel displacement of the motion vector is either, indicated by one class, equiangular one-dimensional approximation of the dependency of difference metric from sub-pixel displacement, which is considered in one or several directions (described below with reference to FIG. 6) or, indicated by the other class, two-dimensional approximation of the dependency of difference metric from sub-pixel displacement by a conic surface (described below with reference to FIG. 7).

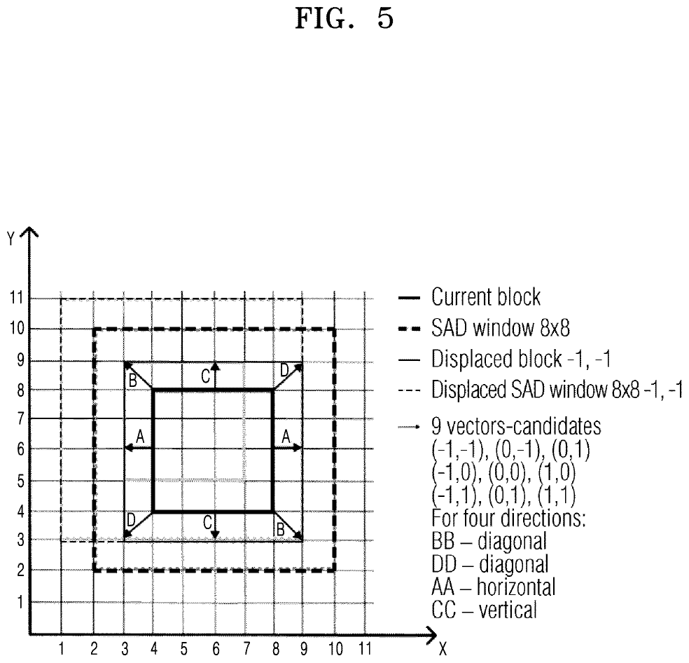

Next, at sub-operation S115.3, the sub-pixel displacement of the motion vector is found (calculated) using the method indicated by the determined class, and at sub-operation S115.4, the found sub-pixel displacement of the motion vector is verified. As the non-limiting example at the sub-operation S115.4 the found sub-pixel displacement is checked not to indicate beyond a permissible range set, for example, by a difference metrics/similarity metrics determining window, which example is illustrated in FIG. 5, and/or the found sub-pixel displacement is checked not to be substantially equal to zero. In case the found sub-pixel displacement of the motion vector is verified successfully (i.e., it is not beyond the range and/or is not substantially equal to zero), at sub-operation 115.5-1 the motion vector is refined based on the found sub-pixel displacement of the motion vector. The refinement of the motion vector based on a successfully verified sub-pixel displacement has a floating-point number format or a fixed-point number format. If the found sub-pixel displacement of the motion vector is not verified successfully, at sub-operation 115.5-2 the refinement of the motion vector based on the found sub-pixel displacement of the motion vector is skipped.

The following describes the non-limiting example of the implementation of motion vector refinement operation S115 and provides corresponding mathematical description. This example and any mathematical expressions that follow should not be interpreted as limiting, as other possible modifications to the implementation of motion vector refinement at operation S105 will become apparent to those of ordinary skill in the art after reading this disclosure. All such modifications are intended to be within the scope of the appended claims of the disclosure.

Refinement of the motion vector of a block, which may be a pixel (in the case when the block-based motion estimation performed at operation S110 is pixel-wise, i.e., when the block size is equal to a pixel) with coordinates (i, j) or a frame portion at the position indicated by coordinates (i, j) can be carried out only if a certain condition is met for this block. This condition may be related to noise and/or image details. The example of the condition related to both noise and image details is Cᵢⱼ¹+Cᵢⱼ²>threshold1, where the threshold value threshold1 can be selected from the range 0 to 2, in the preferred embodiment threshold1=1. The example of the condition related to noise only is Cᵢⱼ¹>threshold2, where the threshold value threshold2 can be selected from the range 0 to 1, in the preferred embodiment threshold2=0,5. The example of the condition related to image details only is Cᵢⱼ²>threshold3, where the threshold value threshold3 can be selected from the range 0 to 1, in the preferred embodiment threshold3=0,5. The rationale for applying such conditions is that in some frame blocks, the refinement of the motion vectors found for them is not appropriate, since they contain too much noise (i.e., no refinement will help in these blocks, see, for example, the area of the dark vase in the background in the motion refinement map illustrated in FIG. 9) and/or they lack any significant image details (see, for example, sole-colored region of the sofa in the lower right corner of the motion refinement map illustrated in FIG. 9).

Verification of the fulfillment of the condition described above can be performed for each block found by the motion estimation at operation S110. If such a condition is met for certain block, the motion vector found for this block is refined, otherwise, the motion vector found for this block is not refined. The refinement itself generally includes the following operations: (1) calculating k≥9 difference metrics/similarity metrics between a candidate block Mᵢⱼ of the best motion (Dₓ, D_{y}) found at operation S110 and spatially adjacent blocks (integral (when the block-based motion estimation at operation S110 is pixel-wise) and/or overlapping with the candidate block Mᵢⱼ (when blocks of estimated motion at operation S110 consist of at least two pixels)), (2) fitting Lₓ function that approximates values of found k≥9 difference metrics/similarity metrics and (3) calculating the refined motion vector as:

$${R}_{ij} = {argmin}_{x , y} {L}_{x} \qquad Equation 11$$

where argmin is a minimization argument calculated analytically from the parameter of the fitted function Lₓ and providing a sub-pixel value of the refined motion vector. The sub-pixel range achievable with such refinement is the range from ˜½ pixel to ˜ 1/16 pixel.

As mentioned above, the above described classifier is used at sub-operation S115.2, which indicates the most appropriate (for the calculated k≥9 difference metrics/similarity metrics) method of finding sub-pixel displacement of the motion vector. One indicated method is (a) equiangular one-dimensional approximation of difference metric versus sub-pixel displacement, which is considered in one or several directions, and the other indicated method is (b) two-dimensional approximation of difference metric versus sub-pixel displacement by a conic surface.

Next, the non-limiting example of the implementation of the method (a) of equiangular one-dimensional approximation of difference metric versus sub-pixel displacement considered in one or several directions is described with reference to FIG. 6. This example and any mathematical expressions that follow should not be interpreted as limiting, as other possible modifications to said implementation will become apparent to those of ordinary skill in the art after reading this disclosure. All such modifications are intended to be within the scope of the embodiment of the disclosure.

The method (a) starts from (1) selecting one or more directions in which there is a maximum gradient of difference metric/similarity metric. In FIG. 5 possible directions are indicated by arrows from the current block. A cell in FIG. 5 can be one pixel or a block of two or more pixels. Then (2) searching for sub-pixel displacements dm, dn along a line of difference metric decreasing or a line of similarity metric increasing. As an example, in FIG. 6 three values of the difference metric obtained along the selected direction (for example, the direction AA in FIG. 5) are shown with bold dots, it is known from experience that the line of difference metric decreasing is best approximated by equiangular segments shown in FIG. 6 with thick and thin lines, then the lowest point (which is approached by the thin line that continues the thick line, and after which the difference metric begins to increase again) is the searched point at which the minimum difference metric indicated on the y-axis is provided, and for which the required displacements dm, dn are determined on x-axis. For the case where each cell shown in FIG. 5 is equal to one pixel, sub-pixel displacement ranges are given as 1≤dm≤1 and 1≤dn≤1 for one or more selected directions. In other cases, the specified ranges may be adjusted appropriately.

Finally, after finding displacements dm, dn, motion vector refined to sub-pixel precision is calculated (3). For straight directions (for example AA, CC in FIG. 5), this calculation (3) can be carried out as follows:

$$Dspx = Dx + dm \qquad Equation 12$$

$$Dspy = Dy + dn \qquad Equation 13$$

And for diagonal directions (for example, BB, DD in FIG. 5), this calculation (3) can be carried out as follows:

$$Dspx = Dx + dm / √ 2 \qquad Equation 14$$

$$Dspy = Dy + dn / √ 2 \qquad Equation 15$$

Further, with reference to FIG. 7 the non-limiting example of the implementation of the method (b) of two-dimensional approximation of difference metric versus sub-pixel displacement by a conic surface. This example and any mathematical expressions that follow should not be interpreted as limiting, as other possible modifications to said implementation will become apparent to those of ordinary skill in the art after reading this disclosure. All such modifications are intended to be within the scope of the embodiment of the disclosure.

Approximation by conical surface can be performed according to the following equation:

$${L}_{d} ( {a}_{0} … {a}_{5} , [ , {S}_{0} ] ) = {\sum }_{i} {( {a}_{0} + {a}_{1} {x}_{i} + {a}_{2} {y}_{i} + {a}_{3} {x}_{i}^{2} + {a}_{4} {y}_{i}^{2} + {a}_{5} {x}_{i} {y}_{i} - {( Si - {S}_{0} )}^{2} )}^{2} \qquad Equation 16$$

where
L_{d} is the objective function for conical surface approximation, which is reduced to a linear regression problem;
a₀ . . . a₅ are the desired linear regression coefficients;
S₀ is a preliminary value estimate of the minimum difference metric under the condition of ideal sub-pixel motion vector refinement;
S₁ . . . Sₖ are known difference metric values for the corresponding block 1 . . . k.
x₁ . . . xₖ are integer abscissas of coordinates of the best candidate block found at operation S110 and adjacent k−1 blocks; and
y₁ . . . yₖ are integer ordinates of coordinates of the best candidate block found at operation S110 and adjacent k−1 blocks.

In the non-limiting implementation example (1a), at operation (1) the value S₀ is assumed equal to half of the minimum value of the difference metrics among the k-candidates. In the other implementation example (1b), at operation (1) the value S₀ is assumed as the one obtained from the noise prediction map Nᵢⱼ obtained at operation S105, for example, by performing linear transformation of the predicted noise value in the vicinity of the best candidate block, for example, with a coefficient from 0.75 to 1.50 and an offset of about 0.

Then, at operation (2), the linear regression coefficient vector A is searched with the least squares method by addressing the following system of equations:

$$X = ( \begin{matrix}1 & {x}_{0} & {y}_{0} & {x}_{0}^{2} & {y}_{0}^{2} & {x}_{0} {y}_{0} \\ ⋮ & ⋮ & ⋮ & ⋮ & ⋮ & ⋮ \\ 1 & {x}_{9} & {y}_{9} & {x}_{9}^{2} & {y}_{9}^{2} & {x}_{9} {y}_{9}\end{matrix} ) \qquad Equation 17$$

$$\dot{Y} = ( \begin{matrix}{S}_{1} & … & {S}_{9} )\end{matrix}$$

$$Y = {( \dot{Y} - \frac{min ( {S}_{i} )}{2} )}^{2}$$

where
X is a rectangular matrix including the known integer coordinate values of the best candidate block found at operation S110 and adjacent k−1 blocks;
\dot{Y} is a vector of known values of the metric of difference among k candidates;
Y is a vector of known values of the metric of difference among k candidates, which is displaced by the value S₀ defined according to the above example (1a);

$$A = ( \begin{matrix}{a}_{0} & … & {a}_{6} )\end{matrix} \qquad Equation 18$$

where A is the searched linear regression coefficient vector. To find the searched vector A (18), the equation known in the art for the analytical solution of the linear regression problem is used:

$${( {X}^{T} X )}^{- 1} {X}^{T} Y \qquad Equation 19$$

When the vector A is found, the first and second derivatives of the function L_{d} with found coefficients A are checked (3) at the point with the coordinates of the best candidate block found at operation S110. It is known that the analytic function has an extremum at the point where the derivative of the function is equal to 0. It is also known that if the second derivative at the extremum point is positive, then the extremum is at least a local minimum of the function. If both derivatives are greater than 0, then proceeding to operation (4), otherwise, concluding that the calculation of the sub-pixel displacement by the method (b) of two-dimensional approximation of difference metric versus sub-pixel displacement by a conic surface is unreliable, and proceeding to operation (5). At operation (4), the coefficients are substituted into the first derivative equation and the equation is addressed. The solution to the equation is the sub-pixel displacement illustrated in FIG. 7. At operation (5), the task is divided into eight tasks, each of which is addressed by the above-described method (a) of equiangular one-dimensional approximation. Based on the found coefficients, the minimum value of S is found by substituting the x, y coordinates of the border (left, right, top, bottom, corners). Alternative loss functions usable to perform conical surface approximation may be expressed as follows:

$${L}_{A} ( x , y ) = {\sum }_{i} \qquad Equation 20$$

$${( \sqrt{{{a}_{1} ( xi - {x}_{0} )}^{2} + {a}_{2} {( yi - {y}_{0} )}^{2} + {a}_{3} ( xi - {x}_{0} ) ( yi - {y}_{0} )} + {a}_{0} - Si )}^{2}$$

$${L}_{B} ( x , y ) = {\sum }_{i} \qquad Equation 21$$

$$\vert {{a}_{1} ( {x}_{i} - {x}_{0} )}^{2} + {a}_{2} {( {y}_{i} - {y}_{0} )}^{2} + {a}_{3} ( {x}_{i} - {x}_{0} ) ( {y}_{i} - {y}_{0} ) - {( Si - {a}_{0} )}^{2} \vert$$

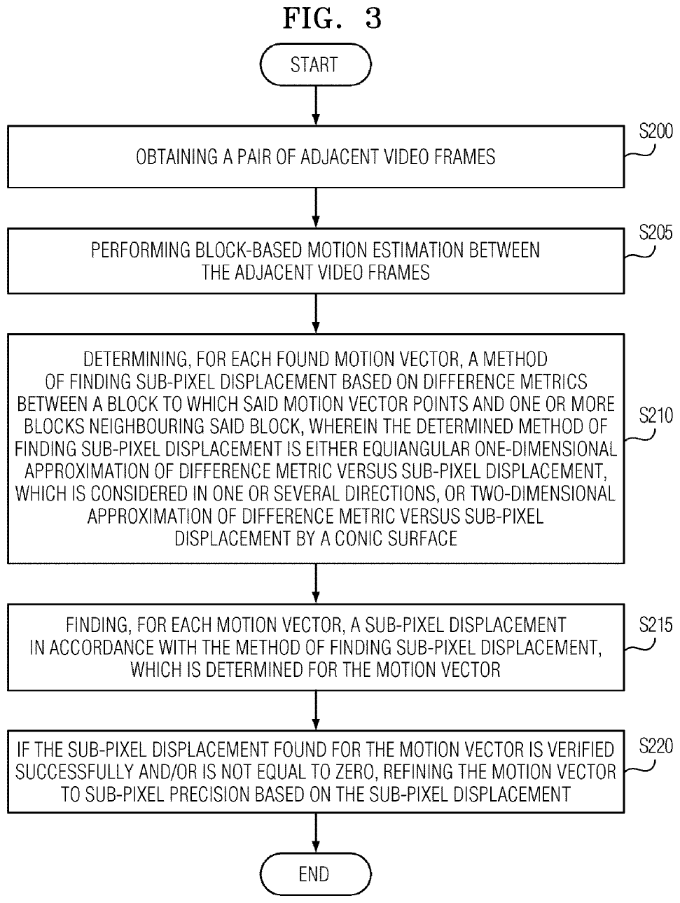

FIG. 3 is a flowchart of a method of sub-pixel refinement of motion vectors according to an embodiment of the disclosure.

In an embodiment of the disclosure, it may overlap parts described in the above specification. Therefore, overlapping parts can be omitted.

The disclosure can be applied in many technical fields and applications. The following are possible applications of the sub-pixel motion vector refinement technology described above.

Temporal noise reduction (TNR). The following briefly describes the sequence of the main operations of TNR: (1) putting at least one input frame into a frame buffer FB0, (2) preprocessing the input frame, including, for example, scaling with a factor s1 and putting it into a frame buffer FB1, and preprocessing the input frame, including, for example, scaling with a factor s2 and putting it into a frame buffer FB2, (3) performing motion estimation ME1, (4) performing motion estimation ME2 using the motion estimate ME1 as a motion prediction, (5) performing noise block erosion, BE, (6) calculating a noise prediction map for the first scaled frame using a predefined noise model obtained in advance, (7) performing sub-pixel motion refinement for a portion of the frame for which the noise prediction is below a threshold level T1, (8) performing motion compensation, MC, of the input frame using the motion vector, MV, field obtained at operation (7), including, for example, occlusion detection, occlusion correction, interpolation pixel remapping, (9) performing temporal filtering using the motion compensated frame obtained at operation (8) and at least one frame from the frame buffer FB0. Optionally, one may further update FB0 with the TNR result and/or post-process the TNR result, including, for example, its spatial filtering. At least the above operations (6)-(7) may be performed according to the technology described in this application.

Frame rate up conversion (FRUC). The following briefly describes the sequence of the main operations of FRUC (1) putting at least one input frame into a frame buffer FB1, (2) preprocessing the input frame, including, for example, scaling with a factor s1 and putting it into a frame buffer FB2, (3) performing motion estimation ME, (4) performing block erosion, BE, (5) calculating a noise prediction map for the scaled frame using a predefined noise model obtained in advance, (6) performing sub-pixel motion refinement for a portion of the frame for which the noise prediction is below a threshold level T1, (7) copying the ME result to the motion buffer, MB, (8) performing motion compensation, MC, of the input frame using the motion vector, MV, field obtained at operation (7), including, for example, occlusion detection, occlusion correction, interpolation pixel remapping, (9) copying the interpolated frame into an output stream buffer. At least the above operations (5)-(6) may be performed according to the technology described in this application. As the other non-limiting example, the technology described in this application may be applied to the frame rate conversion technology described in the Russian patent application RU 2022111860 (SAMSUNG ELECTRONICS CO., LTD.), the full disclosure of which is incorporated herein by reference.

Other technical fields and applications in which the sub-pixel motion vector refinement technology described above may find application include structure from motion (SfM) and three-dimensional (3D) reconstruction, object tracking in video, video compression, dense optical flow estimation, which is part of the core API of many frameworks (Nvidia IP and OF SDK, Apple Vision and CoreImage, or the like). Therefore, the technology described in this application can be widely used in real-time video processing on resource-constrained devices (for example, mobile phones, tablets, televisions (TVs)), for example, when playing video, when making a video call, when converting video at the time of its capturing, and the technology is easily adaptable to new use cases with specific video processing requirements.

Technical experiments carried out by authors of the inventors on mobile devices with limited computing resources acknowledge the reduction in execution time of the proposed sub-pixel motion refinement method by an average of 4.6 ms, as well as the improvement in PSNR by an average of 0.8 dB. More detailed information about the experiments performed and the experimental data obtained may be provided if necessary.

FIG. 4 is a block diagram of an electronic device according to an embodiment of the disclosure.

Referring to FIG. 4, an electronic device 300 may include a camera/ISP, a processor 310, and memory 320 interconnected by bidirectional lines for signals, data, and executable instructions. The processor 310 may include a sub-pixel motion vector refining unit as well as a video encoder/decoder, for example. The sub-pixel motion vector refining unit may be configured, upon execution of processor executable instructions, to perform any of the methods described above or below, or to perform any one or more aspects of any of the methods described above or below. Non-limiting examples of the electronic device 300 include any electronic device such as a smartphone, tablet, computer, television, set-top box, medical equipment, digital camera, and so on. In the non-limiting scenario of the electronic device 300 operation, camera obtains at least a pair of adjacent video frames, and the sub-pixel motion vector refining unit processes these frames according to the method disclosed herein or according to any aspect of the method disclosed herein.

The processor 310 may call and execute computer programs from the memory 320 to perform the disclosed method. The processor 310 may include one or more processors. The one or more processors can be one or more of the following processors a general-purpose processor (for example, CPU), an application processor (AP), graphics processing unit (GPU), a vision processing unit (VPU), a dedicated AI processor (for example, NPU). In hardware, the processor 310 may be implemented as a digital signal processor (DSP), system on a chip (SOC), application specific integrated circuit (ASIC), field programmable gate array (FPGA), or other programmable logic device (PLD), discrete logic element, transistor logic, discrete hardware components, or any combination thereof. In addition, the general-purpose processor may be a microprocessor, controller, microcontroller, or state machine. The processor may also be implemented as a combination of electronic devices (e.g., a combination of DSP and microprocessor, multiple microprocessors, one or more microprocessors in combination with DSP core, or any other such configuration).

The memory 320 may include both random access memory (RAM) and read-only memory (ROM). The memory 320 may be a device(s) separate from the processor 310 or may be integrated with the processor 310. Non-limiting examples of read-only memory include basic read-only memory (ROM), programmable read-only memory (PROM), erasable programmable read-only memory (EPROM), electronically erasable programmable read-only memory (EEPROM), or flash memory. Non-limiting examples of random access memory include basic random access memory (RAM), static random access memory (SRAM), dynamic random access memory (DRAM), synchronous dynamic random access memory (synchronous DRAM, SDRAM), synchronous dynamic random access memory with double data rate (SDRAM with double data rate, DDR SDRAM), enhanced synchronous dynamic random access memory (enhanced SDRAM, ESDRAM), synchronous link DRAM (SLDRAM), and direct Rambus random access memory (DR RAM).

FIG. 5 is a graph illustrating calculation difference metrics when refining the motion vector according to an embodiment of the disclosure.

FIG. 6 is a graph illustrating equiangular one-dimensional approximation of difference metric versus sub-pixel displacement, which is considered in one or several directions, which can be used as one of the possible methods of finding sub-pixel displacement of the motion vector according to an embodiment of the disclosure.

FIG. 7 is a graphical representation of two-dimensional approximation of difference metric versus sub-pixel displacement by a conic surface, which can be used as the other of the possible methods of finding sub-pixel displacement of the motion vector according to an embodiment of the disclosure.

FIG. 8 is a graphical representation of a predefined noise model applied in the method of sub-pixel refinement of motion vectors when determining a noise prediction map for a frame according to an embodiment of the disclosure.

FIG. 9 illustrates a noisy image, a noise prediction map, a lower noise map, a standard deviation map of image pixel intensity values, an image details map, and a motion refinement map according to an embodiment of the disclosure.

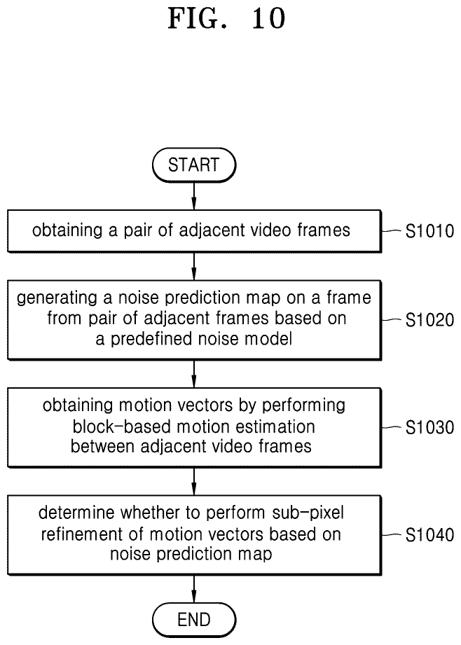

FIG. 10 is a flowchart of a method for sub-pixel refinement of motion vectors according to an embodiment of the disclosure.

Referring to FIG. 10, at operation S1010, the electronic device 300 may obtain a pair of adjacent video frames. In an embodiment of the disclosure, the obtaining of a pair of adjacent video frames may be performed in the same or similar way, and the same description is omitted because it is redundant.

At operation S1020, the electronic device 300 may generate a noise prediction map on a frame from the pair of adjacent frames based on a predefined noise model. In an embodiment of the disclosure, the electronic device may obtain or generate a noise prediction map for the frame from the pair of the adjacent frames by using the predefined noise model.

In an embodiment of the disclosure, the predefined noise model may be obtained. For example, the predefined noise model may be generated with camera sensor, or transmitted from a server with the predefined noise model.

In an embodiment of the disclosure, the predefined noise model may be generated by performing at least one operation. The at least one operation may include capturing, using the camera sensor, a plurality of sets of frames. The frames of each set may be captured in a static position for a static scene with fixed illumination, exposure, sensor sensitivity, and focus. The at least one of static position, illumination, exposure, sensor sensitivity and focus in one set of frames may differ from that in any other set of frames.

The at least one operation may include determining parameters including pixel position, camera sensor gain level when capturing the frame, standard deviation of pixel intensity values, and mean pixel luminosity value corresponding to a portion of each frame. The pixel position may be indicated the frame portion position within frame centered at pixel (x,y) or a distance from center of the frame to pixel (x,y). The pixel position may be referred as radius.

The at least one operation may include obtaining the approximated model to predict a noise of the frame as the predefined noised model based on the determined parameters. The approximation of a model may be performed for predicting the standard deviation with the pixel position, the camera sensor gain level, and the mean pixel luminosity value. Based on the determining of a plurality of parameters corresponding to each scene, the plurality of the parameters may be saved in database of the electronic device or server. By performing approximation the plurality of the parameters, the model for predicting a noise of the frame may be generated. In an embodiment of the disclosure, the predefined noise model may be stored in the server. The electronic device 300 may obtain a noise prediction map by using the predefined noise model stored in the electronic device 300 or a noise prediction map by using a predefined noise model stored in the server.

In an embodiment of the disclosure, the frame from the pair of adjacent frames may be preprocessed by filtering or downscaling. And, the noise prediction map may be generated by inputting the preprocessed frame into the predefined noise model.

Meanwhile, the preprocessing operation, means to process at least one frame in order to perform subsequent operations, is not limited to the disclosed example.

At operation S1030, the electronic device 300 may obtain the motion vectors by performing block-based motion estimation between the adjacent video frames.

In an embodiment of the disclosure, the electronic device may obtain the motion vectors by performing block-based motion estimation between the adjacent video frames. For the motion estimation about the adjacent video frames, the adjacent video frames may be preprocessed by filtering or downscaling. And, through iteration of forward motion estimation and backward motion estimation, quantized motion vectors may be obtained. The quantized motion vectors may be referred as motion vectors.

Meanwhile, the preprocessing operation is not limited to the disclosed example.

At operation S1040, the electronic device 300 may determine whether to perform the sub-pixel refinement of the motion vectors based on the noise prediction map.

In an embodiment of the disclosure, the electronic device may obtain an image details map for indicating where the image has details including at least one of edges, and fine features. The electronic device may determine whether to perform the sub-pixel refinement of the motion vectors based on the noise prediction map and/or the image details map. A detailed description related to this will be omitted since it overlaps with the above description.

In an embodiment of the disclosure, the electronic device may obtain motion refinement map for determining a portion of the frame where to perform the sub-pixel refinement based on the noise prediction map. And the electronic device may obtain the at least one block of the frame to perform sub-pixel refinement by the motion refinement map.

In an embodiment of the disclosure, if it is determined not to perform the sub-pixel refinement of the motion vectors, the motion refinement may be skipped. If it is determined to perform the sub-pixel refinement of the motion vectors, the electronic device may perform the sub-pixel refinement of the motion vectors for at least one block of the frame based on the determination to perform the sub-pixel refinement of the motion vectors. The at least one block to perform the sub-pixel refinement of the motion vectors may include the obtained at least one block by the motion refinement map.

In an embodiment of the disclosure, the performing of the sub-pixel refinement of motion vectors may include at least one of obtaining match metrics associated with neighboring blocks of a block pointed to by a motion vector included in the motion vectors, classifying the match metrics into a class included in at least two classes to find sub-pixel displacement of the motion vector to a frame region that has minimum difference with the block, finding sub-pixel displacement of the motion vector with the class included in the at least two classes, and adjusting the motion vector by the found sub-pixel displacement. The at least two classes to find the sub-pixel displacement may include equiangular approximation, and conic surface approximation. In an embodiment of the disclosure, the classifying of the match metrics may be performed by a classification model for trained to predict the best way to find the approximate position of match metric minima.

In an embodiment of the disclosure, wherein the adjusting of the motion vector by the found sub-pixel displacement may include verifying the found sub-pixel displacement of the motion vector. And if the found sub-pixel displacement of the motion vector is verified successfully, the electronic device may refine the motion vector based on the found sub-pixel displacement of the motion vector, or if the found sub-pixel displacement of the motion vector is not verified successfully, the electronic device may skip the refinement of the motion vector based on the found sub-pixel displacement of the motion vector. A detailed description related to this will be omitted because it has been described above and is redundant.

Meanwhile, the performing of the sub-pixel refinement of motion vectors may be performed in each pixel corresponding to the at least one block to perform the sub-pixel refinement of the motion vector, or the obtained at least one block by the motion refinement map.

In one embodiment of the disclosure, the electronic device may obtain a finely adjusted frame through at least one operation or operation described above.

It is an embodiment of the disclosure to provide an accurate motion estimation method that can be implemented on resource-constrained mobile devices while providing at least improved picture quality (e.g., based on peak signal-to-noise ratio (PSNR)). An embodiment of the disclosure is to achieve accurate motion estimation even in the presence of noise in the original images over a wide range of noise levels. An embodiment of the disclosure is to reduce the time it takes to perform motion estimation on resource-constrained devices. In general, it can be said that the solution proposed in this application improves the efficiency of image encoding/decoding due to improvements in the motion estimation procedure itself and/or the disclosed solution is adapted for implementation on resource-constrained devices at least due to minimization of the operations that shall be performed on such devices directly in the process of processing/capturing images (i.e. in real time, when the device is used by the end user).

An embodiment of the disclosure is achieved, in general, by processing, in certain operations, frames having reduced resolution (to reduce noise and reduce complexity) with subsequent refinement of the motion estimation to sub-pixel precision. An additional advantage of the disclosed method in one aspect consists in using a pre-configured noise model adapted to a specific camera (i.e., its sensor and/or the image-processing pipeline applied), which allows noise prediction without performing resource-intensive collection/analysis of any statistics for the processed images.

Therefore, according to an embodiment of the disclosure provided is a method of sub-pixel refinement of motion vectors, which includes: obtaining a pair of adjacent video frames, determining a noise prediction map on a frame from said pair of adjacent frames based on a predefined noise model, performing block-based motion estimation between the adjacent video frames downscaled, and if, for a block, a condition associated with the noise indicated by the noise prediction map for said block is satisfied, refining a motion vector associated with such block to sub-pixel precision.

According to an embodiment of the disclosure provided is a method of sub-pixel refinement of motion vectors, which includes: obtaining a pair of adjacent video frames, performing block-based motion estimation between the adjacent video frames, determining, for each found motion vector, a method of finding sub-pixel displacement based on difference metrics between a block to which said motion vector points and one or more blocks neighboring said block, wherein the determined method of finding sub-pixel displacement is either equiangular one-dimensional approximation of difference metric versus sub-pixel displacement, which is considered in one or several directions, or two-dimensional approximation of difference metric versus sub-pixel displacement by a conic surface, finding, for each motion vector, a sub-pixel displacement in accordance with the method of finding sub-pixel displacement, which is determined for the motion vector, and if the sub-pixel displacement found for the motion vector is verified successfully and/or is not equal to zero, refining the motion vector to sub-pixel precision based on the sub-pixel displacement.

According to an embodiment of the disclosure provided is an electronic device including a camera configured to capture video images, and a processor configured to, when executing processor-executable instructions stored in memory, perform on at least two captured video images a method of sub-pixel refinement of motion vectors according to the first embodiment or any further implementation aspect thereof, or according to the second embodiment or any further implementation aspect thereof.

According to an embodiment of the disclosure provided is a computer-readable storage medium storing computer-executable instructions that, when executed by a computer, cause the computer to perform a method of sub-pixel refinement of motion vectors according to the first embodiment or any further implementation aspect thereof, or according to the second embodiment or any further implementation aspect thereof.

In an embodiment of the disclosure, a method of sub-pixel refinement of motion vectors, the method may include the operations of obtaining a pair of adjacent video frames at operation S100, determining a noise prediction map on a frame from said pair of adjacent frames based on a predefined noise model at operation S105, performing block-based motion estimation between the downscaled adjacent video frames at operation S110, and if, for a block, a condition associated with the noise indicated by the noise prediction map for the block is satisfied, refining a motion vector associated with the block to sub-pixel precision at operation S115.

In an embodiment of the disclosure, the predefined noise model may be obtained in advance for a particular camera sensor and applied image-processing pipeline by performing the operations of capturing, using said camera sensor and the applied image-processing pipeline, a plurality of sets of frames, wherein frames of each set are captured in a static position for a static scene with fixed illumination, exposure, sensor sensitivity, and focus, wherein at least one of static position, illumination, exposure, sensor sensitivity and focus in one set of frames differs from that in any other set of frames, specifying a plurality of portions in each frame of each set, and determining a position of each portion in the frame, in each set of frames between frame portions in a same position, determining following characteristics: standard deviation of pixel intensity values, mean pixel luminosity value, and camera sensor gain level when capturing the frame, and obtaining, by approximating determined positions of frame portions and the characteristics determined therein with a low-parametric function, a low-dimensional parametric noise model configured to determine a noise prediction map for an arbitrary frame captured using said particular camera sensor and the image-processing pipeline applied.

In an embodiment of the disclosure, a position of each portion in a frame may be determined as a relative distance of the considered frame portion from a center of the frame.

In an embodiment of the disclosure, at operation S105, the noise prediction map may be determined for each frame portion by predicting standard deviations of pixel intensity values of the frame portion as a function of a position of the frame portion and a mean pixel luminosity value of the frame portion, as well as a camera sensor gain level when capturing the corresponding frame.

In an embodiment of the disclosure, the condition being checked to determine whether it is reasonable to refine the motion vector to sub-pixel precision for the block may be further associated with image details indicated for said block by image details map obtained based on the noise prediction map.

In an embodiment of the disclosure, at operation S115, the refining of the motion vector associated with the block to sub-pixel precision may include the sub-operations of: calculating difference metrics between a block pointed to by the motion vector and each block of at least k blocks neighboring said block at operation S115.1, classifying an array of calculated difference metrics into one of at least two classes with a classifier, wherein a class determined by the classifier indicates a method of finding sub-pixel displacement of the motion vector to a frame region that has minimum difference with the block from which the motion vector points at operation S115.2, finding sub-pixel displacement of the motion vector with the method indicated by the determined class at operation S115.3, verifying the found sub-pixel displacement of the motion vector at operation S115.4, and if the found sub-pixel displacement of the motion vector is verified successfully, refining the motion vector based on the found sub-pixel displacement of the motion vector at operation S115.5-1, or if the found sub-pixel displacement of the motion vector is not verified successfully, skipping the refinement of the motion vector based on the found sub-pixel displacement of the motion vector at operation S115.5-2.

In an embodiment of the disclosure, at operation S115.1, each neighboring block of the at least k blocks used in calculating the difference metric may be a block that has the same shape, height and width in pixels as the block to which said motion vector points.

In an embodiment of the disclosure, at operation S115.1, each neighboring block of the at least k blocks used in calculating the difference metric may be a block that does not overlap with the block to which said motion vector points or at least partially overlaps with the block to which said motion vector points.

In an embodiment of the disclosure, the method of finding sub-pixel displacement of the motion vector may be either equiangular one-dimensional approximation of difference metric versus sub-pixel displacement, which is considered in one or several directions, or two-dimensional approximation of difference metric versus sub-pixel displacement by a conic surface.

In an embodiment of the disclosure, the block for which the condition is checked to determine whether it is reasonable to refine the motion vector to sub-pixel precision may be a block from which the found motion vector points, and/or a block to which the found motion vector points.

In an embodiment of the disclosure, at operation S110, the block obtained by partitioning the frame in motion estimation may have a size of one pixel or more.

In an embodiment of the disclosure, the method may include the operations of obtaining a pair of adjacent video frames at operation S200, performing block-based motion estimation between the adjacent video frames at operation S205, determining, for each found motion vector, a method of finding sub-pixel displacement based on difference metrics between a block to which said motion vector points and one or more blocks neighboring said block, wherein the determined method of finding sub-pixel displacement is either equiangular one-dimensional approximation of difference metric versus sub-pixel displacement, which is considered in one or several directions, or two-dimensional approximation of difference metric versus sub-pixel displacement by a conic surface at operation S210, finding, for each motion vector, a sub-pixel displacement in accordance with the method of finding sub-pixel displacement, which is determined for the motion vector at operation S215, and if the sub-pixel displacement found for the motion vector is verified successfully and/or is not equal to zero, refining the motion vector to sub-pixel precision based on the sub-pixel displacement at operation S220.

In an embodiment of the disclosure, the electronic device 300 for the sub-pixel refinement of the motion vectors may include a camera configured to capture video images, and a processor 310 configured to, when executing processor-executable instructions stored in memory 320, perform on at least two captured video images a method of sub-pixel refinement of motion vectors according a method of sub-pixel refinement of motion vectors. The method may include the operations of obtaining a pair of adjacent video frames at operation S100, determining a noise prediction map on a frame from said pair of adjacent frames based on a predefined noise model at operation S105, performing block-based motion estimation between the downscaled adjacent video frames at operation S110, and if, for a block, a condition associated with the noise indicated by the noise prediction map for the block is satisfied, refining a motion vector associated with the block to sub-pixel precision at operation S115.

In an embodiment of the disclosure, a computer-readable storage medium storing computer-executable instructions that, when executed by a computer, cause the computer to perform a method of sub-pixel refinement of motion vectors. The method may include the operations of obtaining a pair of adjacent video frames at operation S100, determining a noise prediction map on a frame from said pair of adjacent frames based on a predefined noise model at operation S105, performing block-based motion estimation between the downscaled adjacent video frames at operation S110, and if, for a block, a condition associated with the noise indicated by the noise prediction map for the block is satisfied, refining a motion vector associated with the block to sub-pixel precision at operation S115.

In an embodiment of the disclosure, a method for sub-pixel refinement of motion vectors is provided. The method may include obtaining a pair of adjacent video frames at operation S1010. The method may include generating a noise prediction map on a frame from the pair of adjacent frames based on a predefined noise model at operation S1020. The method may include obtaining the motion vectors by performing block-based motion estimation between the adjacent video frames at operation S1030. The method may include determining whether to perform the sub-pixel refinement of the motion vectors based on the noise prediction map at operation S1040.

In an embodiment of the disclosure, the method may include performing the sub-pixel refinement of the motion vectors for at least one block of the frame based on the determination to perform the sub-pixel refinement of the motion vectors.

In an embodiment of the disclosure, the method may include obtaining match metrics associated with neighboring blocks of a block pointed to by a motion vector included in the motion vectors. In an embodiment of the disclosure, the method may include classifying the match metrics into a class included in at least two classes to find sub-pixel displacement of the motion vector to a frame region that has minimum difference with the block. In an embodiment of the disclosure, the method may include finding sub-pixel displacement of the motion vector with the class included in the at least two classes. In an embodiment of the disclosure, the method may include adjusting the motion vector by the found sub-pixel displacement.

In an embodiment of the disclosure, the at least two class to find the sub-pixel displacement may include equiangular approximation, and conic surface approximation.

In an embodiment of the disclosure, at operation S115.4, the method may include verifying the found sub-pixel displacement of the motion vector. The method may include refining the motion vector based on the found sub-pixel displacement of the motion vector if the found sub-pixel displacement of the motion vector is verified successfully at operation S115.5-1. Or, the method may include skipping the refinement of the motion vector based on the found sub-pixel displacement of the motion vector if the found sub-pixel displacement of the motion vector is not verified successfully at operation S115.5-2.

In an embodiment of the disclosure, the method may include obtaining motion refinement map for determining a portion of the frame where to perform the sub-pixel refinement based on the noise prediction map. In an embodiment of the disclosure, the method may include obtaining the at least one block of the frame to perform sub-pixel refinement by the motion refinement map.

In an embodiment of the disclosure, the method may include determining whether to perform the sub-pixel refinement of the motion vectors based on the noise prediction map and an image details map for indicating where the image has details including at least one of edges, and fine features.

In an embodiment of the disclosure, the method may include capturing, using the camera sensor, a plurality of sets of frames, wherein frames of each set are captured in a static position for a static scene with fixed illumination, exposure, sensor sensitivity, and focus, wherein at least one of static position, illumination, exposure, sensor sensitivity and focus in one set of frames differs from that in any other set of frames. In an embodiment of the disclosure, the method may include determining parameters including pixel position, sensor gain level, standard deviation, and mean luminosity corresponding to a portion of each frame. The method may include determine parameters including pixel position, camera sensor gain level when capturing the frame, standard deviation of pixel intensity values, and mean pixel luminosity value corresponding to a portion of each frame. The method may include obtain the approximated model to predict a noise of the frame as the predefined noised model based on the determined parameters.

In an embodiment of the disclosure, the method may include the classifying of the match metrics is performed by a classification model for trained to predict the best way to find the approximate position of match metric minima.

In an embodiment of the disclosure, an electronic device 300 for sub-pixel refinement of motion vectors, may include memory 320 configured to store instructions, and at least one processor 310 configured to execute instructions to obtain a pair of adjacent video frames. The at least one processor 310 configured to execute instructions to generate a noise prediction map on a frame from the pair of adjacent frames based on a predefined noise model. The at least one processor 310 configured to execute instructions to obtain the motion vectors by performing block-based motion estimation between the adjacent video frames. The at least one processor 310 configured to execute instructions to determine whether to perform the sub-pixel refinement of the motion vectors based on the noise prediction map. The at least one processor 310 configured to execute instructions to perform the sub-pixel refinement of the motion vectors for at least one block of the frame based on the determination to perform the sub-pixel refinement of the motion vectors.

In an embodiment of the disclosure, the at least one processor 310 configured to execute instructions to obtain match metrics associated with neighboring blocks of a block pointed to by a motion vector included in the motion vectors. The at least one processor 310 configured to execute instructions to classify the match metrics into a class included in at least two classes to find sub-pixel displacement of the motion vector to a frame region that has minimum difference with the block. The at least one processor 310 configured to execute instructions to find sub-pixel displacement of the motion vector with the class included in the at least two classes. The at least one processor 310 configured to execute instructions to adjust the motion vector by the found sub-pixel displacement.

In an embodiment of the disclosure, the at least two class to find the sub-pixel displacement may include equiangular approximation, and conic surface approximation.

In an embodiment of the disclosure, at operation S115.4, the at least one processor 310 configured to execute instructions to verify the found sub-pixel displacement of the motion vector. The at least one processor 310 configured to execute instructions to refine the motion vector based on the found sub-pixel displacement of the motion vector if the found sub-pixel displacement of the motion vector is verified successfully at operation S115.5-1. Or, the at least one processor 310 configured to execute instructions to skip the refinement of the motion vector based on the found sub-pixel displacement of the motion vector if the found sub-pixel displacement of the motion vector is not verified successfully at operation S115.5-2.

In an embodiment of the disclosure, the at least one processor 310 configured to execute instructions to determine whether to perform the sub-pixel refinement of the motion vectors based on the noise prediction map and an image details map for indicating where the image has details including at least one of edges, and fine features.

In an embodiment of the disclosure, a computer-readable storage medium, storing instructions for executing a method for sub-pixel refinement of motion vectors is provided is provided. The method may include obtaining a pair of adjacent video frames at operation S1010. The method may include generating a noise prediction map on a frame from the pair of adjacent frames based on a predefined noise model at operation S1020. The method may include obtaining the motion vectors by performing block-based motion estimation between the adjacent video frames at operation S1030. The method may include determining whether to perform the sub-pixel refinement of the motion vectors based on the noise prediction map at operation S1040.

Information and signals described herein can be presented using any of a variety of different technologies. For example, data, instructions, commands, information, signals, bits, symbols and elementary signals, which can be given as an example in the above description, can be represented by means of voltages, currents, electromagnetic waves, magnetic fields or particles, optical fields or particles, or any combination thereof.

Functions described herein may be implemented in hardware, software executed by means of the processor, firmware, or in any combination thereof. When implemented in software executed by means of the processor, functions can be stored or supplied as one or more instructions or code on a computer-readable medium. Other examples and implementations are within the scope of the disclosure of the disclosure. For example, due to the nature of the software, functions described above may be implemented using software executed by means of the processor, hardware, firmware, fixed unit, or any combinations thereof. Features that implement functions can also be physically separated in different positions, including according to such a distribution that parts of the functions are implemented in different physical locations.

Computer-readable media include both non-transitory computer storage media and a communication carrier, including any transmission carrier that facilitates transfer of a computer program from one place to another. The non-transitory storage medium can be any available medium that can be accessed via general-purpose or special-purpose computer. As an example, and not the limitation, non-transitory computer-readable media may include random access memory (RAM), read-only memory (ROM), electrically erasable programmable read-only memory (EEPROM), flash memory, ROM on compact discs (CD) or other optical disk storage device, a data storage device on magnetic disks or other magnetic storage devices, or any other non-transitory storage medium that can be used to transfer or store the required program code in the form of instructions or data structures, and which can be accessed via general-purpose or special-purpose computer or general-purpose or special-purpose processor.

It should be understood that this document discloses the principle of operation and main embodiments of the method of sub-pixel refinement of motion vectors and the electronic device 300 implementing said method. But one of ordinary skill in the art, using the disclosure, will be able to implement other embodiments or modifications of the disclosure without making creative efforts.

It should be understood that although terms, such as “first”, “second”, “third”, or the like, may be used herein to describe various elements, components, blocks, regions, portions, classes, these elements, components, blocks, regions, portions, classes should not be limited to these terms. These terms are only used to distinguish one element from another. Thus, a first class may be named as a second class without departing from the scope of the disclosure. As used herein, the term “and/or” includes any and all combinations of one or more of the respective listed positions. Elements mentioned in the singular do not exclude the plurality of such elements, unless otherwise specified. In addition, any specific numerical values specified in this application should not be construed as a specific limitation, since after reading this disclosure, one of ordinary skill in the art will understand other possible, tuned values that can be used. Instead, if a specific numeric value is specified, it should be considered as the mid-range value, which may be equal, depending on hardware and picture quality requirements, ±0.01-40% of said mid-range value.

The functionality of the element specified in the description or the claims as a single element can be implemented in practice by means of several components of the device, and vice versa, the functionality of the elements specified in the description or the claims as several separate elements can be implemented in practice by means of a single component.

In one embodiment of the disclosure, the elements/units of the proposed device are located in a common housing, placed on the same frame/structure/substrate/printed circuit board and connected to each other structurally through assembly (assembly) operations and functionally through communication lines. The communication lines or channels, unless otherwise specified, are standard communication lines known to skilled persons, the material implementation of which does not require inventive efforts. The communication line can be a wire, a set of wires, a bus, a track, a wireless communication line (inductive, radio frequency, infrared, ultrasonic, or the like). Communication protocols over communication lines are known to those skilled in the art and are not specifically disclosed.

The functional communication between elements should mean communication that ensures the correct interaction of these elements with each other and the implementation of one or another functionality of the elements. Particular examples of functional communication may be communication with the ability to exchange information, communication with the ability to transmit electric current, communication with the ability to transmit light, and so on. A specific type of functional communication is defined by the nature of the interaction between the elements, and, unless otherwise specified, is provided by well-known means, using principles well-known in the art.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device for sub-pixel refinement of motion vectors, the method comprising:
obtaining, by the electronic device, a pair of adjacent video frames;
generating, by the electronic device, a noise prediction map on a frame from the pair of adjacent frames based on a predefined noise model;
obtaining, by the electronic device, the motion vectors by performing block-based motion estimation between the adjacent video frames; and
determining, by the electronic device, whether to perform the sub-pixel refinement of the motion vectors based on the noise prediction map.

2. The method of claim 1, further comprising:
performing the sub-pixel refinement of the motion vectors for at least one block of the frame based on a result of determining whether to perform the sub-pixel refinement of the motion vectors.

3. The method of claim 2, wherein the performing of the sub-pixel refinement of motion vectors comprises:
obtaining match metrics associated with neighboring blocks of a block pointed to by a motion vector included in the motion vectors;
classifying the match metrics into a class included in at least two classes to find sub-pixel displacement of the motion vector to a frame region that has minimum difference with the block;
finding sub-pixel displacement of the motion vector with the class included in the at least two classes; and
adjusting the motion vector by found sub-pixel displacement.

4. The method of claim 3, wherein the at least two class to find the sub-pixel displacement include equiangular approximation, and conic surface approximation.

5. The method of claim 3, wherein the adjusting of the motion vector by the found sub-pixel displacement comprises:
verifying the found sub-pixel displacement of the motion vector; and
if the found sub-pixel displacement of the motion vector is verified successfully, refining the motion vector based on the found sub-pixel displacement of the motion vector, or
if the found sub-pixel displacement of the motion vector is not verified successfully, skipping the refinement of the motion vector based on the found sub-pixel displacement of the motion vector.

6. The method of claim 3, wherein the performing of the sub-pixel refinement of the motion vectors comprises:
obtaining motion refinement map for determining a portion of the frame where to perform the sub-pixel refinement based on the noise prediction map; and
obtaining the at least one block of the frame to perform sub-pixel refinement by the motion refinement map.

7. The method of claim 3, wherein the determining of whether to perform the sub-pixel refinement of the motion vectors based on the noise prediction map comprises:
determining whether to perform the sub-pixel refinement of the motion vectors based on the noise prediction map and an image details map for indicating where the image has details including at least one of edges or fine features.

8. The method of claim 1, wherein the predefined noise model is obtained for a camera sensor by performing operations of:
capturing, using the camera sensor, a plurality of sets of frames,
wherein frames of each set are captured in a static position for a static scene with fixed illumination, exposure, sensor sensitivity, and focus, and
wherein at least one of static position, illumination, exposure, sensor sensitivity or focus in one set of frames differs from that in any other set of frames;
determining parameters including pixel position, camera sensor gain level when capturing the frame, standard deviation of pixel intensity values, and mean pixel luminosity value corresponding to a portion of each frame; and
obtaining an approximated model to predict a noise of the frame as the predefined noised model based on the determined parameters.

9. The method of claim 3, wherein the classifying of the match metrics is performed by a classification model for trained to predict the best way to find an approximate position of match metric minima.

10. An electronic device for sub-pixel refinement of motion vectors, the electronic device comprising:
memory storing one or more computer programs; and
one or more processors communicatively coupled to the memory,
wherein the one or more computer programs include computer-executable instructions that, when executed by the one or more processors individually or collectively, cause the electronic device to:
obtain a pair of adjacent video frames,
generate a noise prediction map on a frame from the pair of adjacent frames based on a predefined noise model,
obtain the motion vectors by performing block-based motion estimation between the adjacent video frames, and
determine whether to perform the sub-pixel refinement of the motion vectors based on the noise prediction map.

11. The electronic device of claim 10, wherein the one or more computer programs further include computer-executable instructions that, when executed by the one or more processors individually or collectively, cause the electronic device to:
perform the sub-pixel refinement of the motion vectors for at least one block of the frame based on a result of determining whether to perform the sub-pixel refinement of the motion vectors.

12. The electronic device of claim 11, wherein the one or more computer programs further include computer-executable instructions that, when executed by the one or more processors individually or collectively, cause the electronic device to:
obtain match metrics associated with neighboring blocks of a block pointed to by a motion vector included in the motion vectors,
classify the match metrics into a class included in at least two classes to find sub-pixel displacement of the motion vector to a frame region that has minimum difference with the block,
find sub-pixel displacement of the motion vector with the class included in the at least two classes, and
adjust the motion vector by found sub-pixel displacement.

13. The electronic device of claim 12, wherein the at least two class to find the sub-pixel displacement include equiangular approximation, and conic surface approximation.

14. The electronic device of claim 12, wherein the one or more computer programs further include computer-executable instructions that, when executed by the one or more processors individually or collectively, cause the electronic device to:
verify the found sub-pixel displacement of the motion vector, and
if the found sub-pixel displacement of the motion vector is verified successfully, refine the motion vector based on the found sub-pixel displacement of the motion vector, or
if the found sub-pixel displacement of the motion vector is not verified successfully, skip the refinement of the motion vector based on the found sub-pixel displacement of the motion vector.

15. The electronic device of claim 12, wherein the one or more computer programs further include computer-executable instructions that, when executed by the one or more processors individually or collectively, cause the electronic device to:
obtain motion refinement map for determining a portion of the frame where to perform the sub-pixel refinement based on the noise prediction map, and
obtain the at least one block of the frame to perform sub-pixel refinement by the motion refinement map.

16. The electronic device of claim 12, wherein the one or more computer programs further include computer-executable instructions that, when executed by the one or more processors individually or collectively, cause the electronic device to:
determine whether to perform the sub-pixel refinement of the motion vectors based on the noise prediction map and an image details map for indicating where the image has details including at least one of edges or fine features.

17. The electronic device of claim 10, wherein the one or more computer programs further include computer-executable instructions that, when executed by the one or more processors individually or collectively, cause the electronic device to:
capture, using a camera sensor, a plurality of sets of frames,
wherein frames of each set are captured in a static position for a static scene with fixed illumination, exposure, sensor sensitivity, and focus, and
wherein at least one of static position, illumination, exposure, sensor sensitivity or focus in one set of frames differs from that in any other set of frames,
determine parameters including pixel position, camera sensor gain level when capturing the frame, standard deviation of pixel intensity values, and mean pixel luminosity value corresponding to a portion of each frame, and
obtain the approximated model to predict a noise of the frame as the predefined noised model based on the determined parameters.

18. The electronic device of claim 12, wherein the classifying of the match metrics is performed by a classification model for trained to predict the best way to find an approximate position of match metric minima.

19. One or more non-transitory computer-readable storage media storing one or more computer programs including computer-executable instructions that, when executed by one or more processors of an electronic device for sub-pixel refinement of motion vectors individually or collectively, cause the electronic device to perform operations, the operations comprising:
obtaining, by the electronic device, a pair of adjacent video frames;
generating, by the electronic device, a noise prediction map on a frame from the pair of adjacent frames based on a predefined noise model;
obtaining, by the electronic device, motion vectors by performing block-based motion estimation between the adjacent video frames; and
determining, by the electronic device, whether to perform sub-pixel refinement of the motion vectors based on the noise prediction map.

20. The one or more non-transitory computer-readable storage media of claim 19, the operations further comprising:
performing the sub-pixel refinement of the motion vectors for at least one block of the frame based on a result of determining whether to perform the sub-pixel refinement of the motion vectors.
